(19) United States
(12) Patent Application Publication
(10) Pub. No.: US 2024/0363827 A1
(43) Pub. Date: Oct. 31, 2024

(54) LITHIUM-SULFUR BATTERY AND A METHOD FOR INCREASING ITS CYCLE LIFE

(71) Applicant: National Taiwan University of Science and Technology, Taipei (TW)

(72) Inventors: Bing-Joe Hwang, Taipei (TW); Misganaw Adigo Weret, Taipei (TW); Sheng-Chiang Yang, Taipei (TW); Wei-Nien Su, Taipei (TW)

(21) Appl. No.: 18/640,318

(22) Filed: Apr. 19, 2024

(30) Foreign Application Priority Data
Apr. 29, 2023 (TW) 112116162

(51) Int. Cl. H01M 4/04; H01M 4/02; H01M 4/136; H01M 4/1397; H01M 4/36; H01M 50/491

(52) U.S. Cl. CPC H01M 4/0404; H01M 4/0452; H01M 4/136; H01M 4/1397; H01M 4/366; H01M 2004/027; H01M 2004/028; H01M 50/491

(57) ABSTRACT

A method for increasing the cycle life of an electrochemical device comprises the steps of: providing an electrochemical device comprising a positive electrode, a negative electrode, and a separator, the negative electrode being at least partially or entirely coated with a lithiophilic metal, a metalloid, and/or an alloy layer thereof; charging the electrochemical device, the positive electrode generating a polysulfide shuttling through the separator to the negative electrode and oxidizes the inactive lithium into the active lithium. This method protects the negative electrode current collector from generating copper sulfide, inhibiting the generation of lithium sulfide, allowing the sulfur to continuously participate in the charging and discharging and depositing dense lithium metal, thereby increasing the cycle life of the battery and maintaining its electrical properties.

### FIELD OF INVENTION

The present invention relates to increasing the cycle life of an electrochemical device, particularly a method for increasing the cycle life of an anode-free lithium-sulfur battery.

The method provided by the present invention will provide a preferred embodiment or application as lithium-sulfur battery and give details description hereinafter. However, the present invention has no intention to limit to this embodiment or application. Any suitable transformation or alternation will be considered including in the present invention.

### BACKGROUND OF THE INVENTION

The lithium-ion battery is a well-established electrochemical battery, consisting of four primary components: the positive electrode, the negative electrode, the electrolyte, and the separator. Lithium-containing transition metal oxides, such as nickel oxide, cobalt oxide, and manganese oxide, are commonly used as the positive electrode material, while carbon materials are used as the negative electrode material. The electrolyte is typically composed of a lithium salt and an organic solvent. During the charging process of a lithium-ion battery, lithium ions are extracted from the positive electrode material and transferred to the negative electrode material through the electrolyte. Here, the lithium ions are embedded in the carbon layer of the negative electrode material for storage. Despite being the primary power sources for electric vehicles over the past decade, lithium-ion batteries still face challenges in terms of energy density and safety. Furthermore, the high cost of raw materials, such as nickel, cobalt, and manganese, pose significant obstacles to the development and widespread adoption of lithium-ion batteries.

With the advancement of technology, lithium-sulfur batteries are gaining traction as a new generation of energy technology and are being gradually commercialized. These batteries employ lithium sulfide (Li₂S) as the positive electrode and metal foil, such as copper foil, as the negative electrode in a new type of high-energy-density electrochemical battery. Compared to transition metals such as nickel, cobalt, and manganese, lithium sulfide (Li₂S) is relatively abundant and inexpensive. Lithium-sulfur batteries that use lithium sulfide as the positive electrode material have the potential to achieve five times the storage capacity of current commercial lithium metal batteries or lithium-ion batteries. As a result, they are one of the most promising energy technologies in terms of cost and efficiency.

In the charging and discharging mechanism of lithium-sulfur batteries, when discharging, the reaction of the negative electrode is that the electrons are lost and become the metal ions, and the reaction of the positive electrode is that the sulfur and lithium ions react with the electrons to form sulfides, and the potential difference between the positive and negative electrodes is the discharge voltage provided by the lithium-sulfur battery. Under the effect of the applied voltage, the positive and negative reactions of the lithium-sulfur battery proceed in the reverse direction, which is the charging process. However, during the charging process of lithium-sulfur batteries, polysulfides are formed on the positive electrode of the lithium sulfide and shuttle through the separator to the negative electrode, a phenomenon known as the shuttle effect. These polysulfides will create an insulating metal sulfide layer on the surface of the metal negative electrode or current collector (e.g., copper foil), causing a decline in the overall conductivity of the negative electrode. In addition, sulfur atoms get irreversibly embedded in the metal sulfide layer. As a result, the sulfur atoms in the positive electrode gradually deplete and decrease the electrical properties of the battery after multiple charging cycles. Given this, it is imperative to find ways to enhance the performance of lithium-sulfur battery after multiple charging and discharging cycles.

### SUMMARY OF THE INVENTION

In order to improve the current problem that the electrical properties of lithium-sulfur batteries decrease after multiple charging and discharging cycles, the present invention provides a method for increasing the cycle life of an electrochemical device, comprising the steps of: providing an electrochemical device consisting of at least a positive electrode, a negative electrode, and a separator, the negative electrode being at least partially or entirely coated with a lithiophilic metal, a metalloid, and/or an alloy layer thereof; charging the electrochemical device, wherein the positive electrode generates a polysulfide and shuttles through the separator to the negative electrode, and the lithium ions from the positive electrode deposit a lithium metal layer between the negative electrode and the lithiophilic metal, the metalloid, and/or the alloy layer, the lithium metal layer comprises an active lithium or an inactive lithium; and the polysulfide oxidizes the inactive lithium into the active lithium when the inactive lithium is formed; wherein the polysulfide is MₓS_{y} where M comprises Li, Al, Na, K, Mg, Ca or Zn; x=0˜2 and y=1˜8.

Furthermore, the present invention provides a lithium-sulfur battery that is produced by the aforementioned method. The battery comprises a positive electrode, a negative electrode, and a separator. The negative electrode is at least partially or entirely coated with a lithiophilic metal, a metalloid, and/or an alloy layer thereof, and it does not generate metal sulfide during the charging process of the lithium-sulfur battery.

By the above description, it can be seen that the present invention has the following beneficial effects and advantages:
1. The present invention provides the method for increasing the cycle life of the lithium-sulfur battery by coating the negative current collector with a dense tin/tin-copper alloy layer to protect the negative current collector from generating copper sulfide under the sulfur shuttle effect of polysulfide, allowing the sulfur atoms to continuously participate in charging and discharging, thereby increasing the cycle life of the battery and maintaining its electrical properties.
2. The present invention uses chemical plating to plate the surface of the negative current collector with a dense tin/tin-copper alloy, it is not only to protect the negative current collector from generating copper sulfide, but also the lithium affinity property of tin can reduce the nucleation potential of lithium on the surface of the negative current collector, which facilitates the deposition of lithium on the negative current collector and improves the overall electrical properties.
3. The process of chemical plating is simple and fast, which is suitable for commercial mass production, and can effectively solve the negative effects of polysulfide due to a shuttle effect of lithium-sulfur battery over time, and improve the overall performance of the lithium-sulfur battery.

### BRIEF DESCRIPTION OF THE DRAWINGS

The steps and the technical means adopted by the present invention to achieve the above and other objects can be best understood by referring to the following detailed description of the preferred embodiments and the accompanying drawings.

FIG. 1 is a schematic flowchart of the steps of the method for increasing the cycle life of the lithium-sulfur battery of the present invention;

FIG. 2 is a flowchart of the method for chemical plating on the negative electrode of the present invention;

FIG. 3 is a schematic flowchart of the continuous process of the present invention;

FIG. 4A and FIG. 4B are the schematic diagrams of the surface optical image state of the negative electrode before and after the treatment by chemical plating of the present invention;

FIG. 5A is an X-ray diffraction analysis image of the negative electrode before and after chemical plating corresponding to FIGS. 4A and 4B;

FIG. 5B is the elemental analysis results of focused ion beam (FIB)-scanning electron microscopy (SEM), and focused ion beam (FIB)-X-ray energy dispersion analysis (EDS) for a preferred embodiment of the negative electrode of the present invention;

FIG. 5C is an elemental analysis signal of a bare negative electrode comparative example before and after chemical plating, and the layers coated with the lithiophilic metal, the metalloid, and/or the alloy layer thereof corresponding to FIGS. 4A and 4B;

FIG. 6A and FIG. 6B are the nucleation potential analysis of the comparative example (bare copper foil) and the embodiment of the present invention, respectively;

FIG. 6C and FIG. 6D are the capacitance analysis of the comparative example (bare copper foil) and the embodiment of the present invention, respectively;

FIG. 7A and FIG. 7B are the surface pattern observations (SEM image) of the negative electrode after at least one charge of the lithium-sulfur battery made by the embodiment of the present invention and the comparative example (bare copper foil); and

FIG. 7C and FIG. 7D are the surface pattern observations (SEM image) of the bare copper foil negative electrode after at least one discharge of the lithium-sulfur battery made by the embodiment of the present invention and the comparative example (bare copper foil).

FIG. 8A and FIG. 8B are GC chromatogram of H₂ gas after H₂O titration on inactive (dead) lithium from the negative electrode after couple of lifecycles of the lithium-sulfur battery made by the embodiment of the present invention.

FIG. 9A and FIG. 9B are GC chromatogram of H₂ gas after H₂O titration on inactive (dead) lithium from the negative electrode after couple of life cycles of the lithium-sulfur battery made by the comparative example (bare copper foil).

### DETAILED DESCRIPTION OF THE PREFERRED EMBODIMENTS

Reference will now be made in detail to the presently preferred embodiments of the invention, examples of which are illustrated in the accompanying drawings. Wherever possible, the same reference numbers are used in the drawings and the description to refer to the same or like parts. It is not intended to limit the method by the exemplary embodiments described herein. In the following detailed description, for purposes of explanation, numerous specific details are set forth in order to attain a thorough understanding of the disclosed embodiments. It will be apparent, however, that one or more embodiments may be practiced without these specific details. As used in the description herein and throughout the claims that follow, the meaning of “a”, “an”, and “the” may include reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to.

As used in the description herein and throughout the claims that follow, the meaning of “anode-free” battery of the present invention referred to no any lithium metal on an anode current collector before the battery starts its cycle. The active lithium as described in the present invention is preferred to be lithium components which available or capable to enter or participate in the cycling of the electrochemical reaction. The inactive lithium as described in the present invention is preferred to be the active lithium component transferred into uncycleable SEI or dead lithium which becomes unable to enter or participate in the following cycling of the electrochemical reaction.

### <Method for Increasing the Cycle Life of an Electrochemical Device>

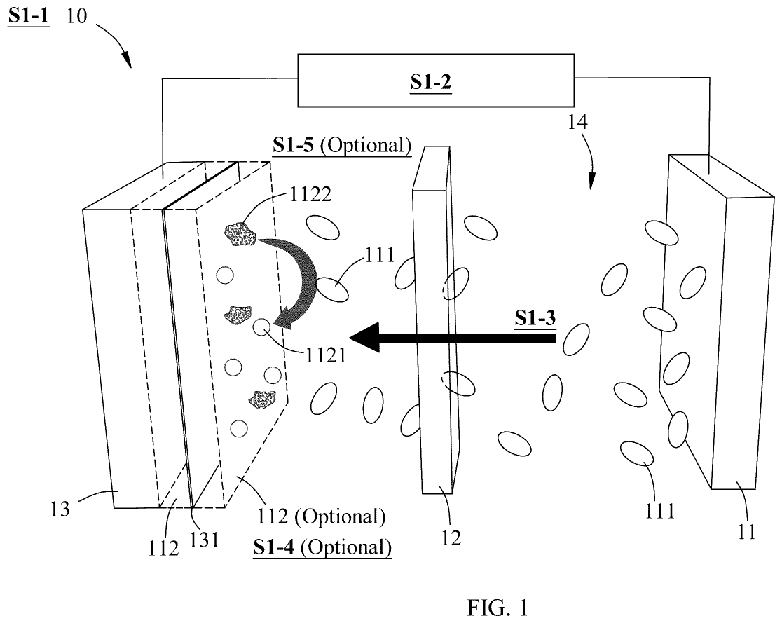

Please refer to FIG. 1, which is a schematic flowchart of the steps of a method for increasing the cycle life of an electrochemical device of the present invention, and the steps of its preferred embodiment comprise:

Step S1-1) Providing an electrochemical device 10 consisting of at least a positive electrode 11, a negative electrode 13, and a separator 12, the negative electrode 13 being at least partially or preferably entirely coated with a lithiophilic metal, a metalloid (by the lithiophilic metal), and/or an alloy layer 131 thereof; preferably, an electrolyte 14 is provided between the positive electrode 11 and the negative electrode 13 and can pass through the separator 12. The negative electrode 13 as mentioned above includes negative current collector for anode-free batteries or negative electrode with active negative electrode material for non-anode-free batteries.

The electrochemical device 10 provided by this embodiment of the present invention is a lithium-sulfur battery, basically the same as any currently existing lithium-sulfur battery. In some possible cases, the positive electrode 11 (also called cathode) contains a positive active material (not shown in the Figures), and the negative electrode 13 may or may not contain a negative active material (not shown in the Figures). When the negative electrode 13 does not contain a negative active material or does not contain any lithium metal on an anode current collector before the battery starts its cycle, the present invention would be a negative electrode (anode) free battery, and the negative electrode 13 is a negative current collector. When the positive electrode 11 of the electrochemical device 10 contains the positive active material, it is preferably to be but not limited to a sulfur-containing positive material for the application of lithium-sulfur battery, such as lithium sulfide (Li₂S). When the present invention is applied to the anode-free battery, the negative current collector is preferably a metal foil, such as a copper foil, an aluminum foil, a nickel foil, a stainless steel or indium foil. The lithiophilic metal, metalloid and/or alloy layer 131 thereof is provided on at least a part and preferably the entire surface of the negative electrode 13, and in a preferred embodiment, the lithiophilic metal, metalloid and/or alloy layer could be a tin layer disposed toward the positive electrode 11. The separator 12 may be any porous film allowing directional shuttling of ions extracted from the positive electrode 11 and/or the negative electrode 13, without limitation herein. The electrolyte 14 may be any electrolyte suitable for the electrochemical device 10, consisting essentially of lithium salt and compatible solvents, without limitation herein and if the electrochemical device is applied as a lithium metal (ion) battery. The aforementioned lithiophilic metal includes strontium, gallium, antimony, magnesium, calcium, barium, scandium, yttrium, aluminum, indium, thallium, germanium, tin, lead, antimony, bismuth, selenium, tellurium, rhodium, iridium, palladium, platinum, silver, gold, zinc, cadmium, titanium, molybdenum, mercury, or combinations thereof; and the lithiophilic metalloid includes carbon, silicon, arsenic, or combinations thereof.

Steps S1-2) Charging the electrochemical device 10, the positive electrode 11 generates a polysulfide 111 and shuttles through the separator 12 to the negative electrode 13; wherein the polysulfide 111 is MₓS_{y} where M comprises Li, Al, Na, K, Mg, Ca or Zn; x=0˜2 and y=1˜8; and

Steps S1-3) (optional) The polysulfide 111 reduces or does not generate a metal sulfide with the negative electrode 13.

Since the negative electrode 13 of the present invention is protected by the lithiophilic metal, the metalloid, and/or the alloy layer 131 thereof, the polysulfide 111 does not generate metal sulfide with the negative electrode 13, which allows the sulfur component to return to the positive electrode 11 during the discharging process and ensures that the sulfur content in the positive electrode 11 is maintained. Consequently, the cycle life of the lithium-sulfur battery is increased.

Steps S1-4) (optional) The lithium ions from the positive electrode 11 deposit a lithium metal layer 112 between the negative electrode 13 and the lithiophilic metal, the metalloid, and/or the alloy layer 131 thereof, and/or on the lithiophilic metal, the metalloid, and/or the alloy layer 131 thereof. Through the lithium affinity of the lithiophilic metal, the metalloid, and/or the alloy layer 131 thereof, the nucleation potential of lithium on the surface of the negative electrode 13 can be reduced, which is beneficial for the deposition of the lithium metal layer 112 on the negative electrode 13, thereby further improving the overall electrical properties of the lithium-sulfur battery 10. On the left side of FIG. 1, for clearly showing the structure of the negative electrode 13, the lithiophilic metal, the metalloid, and/or the alloy layer 131 thereof, and the lithium metal layer 112. The lithium metal layer 112 is shown as dashed lines, which may be distributed between the negative electrode 13 and the lithiophilic metal, the metalloid, and/or the alloy layer 131 thereof. In some preferable embodiments, the lithium metal layer 112 may be distributed on the lithiophilic metal, the metalloid, and/or the alloy layer 131 thereof alone. In other preferable embodiment the lithium metal layer 112 may be distributed between the negative electrode 13 and the lithiophilic metal, the metalloid, and/or the alloy layer 131 thereof, and on the lithiophilic metal, the metalloid, and/or the alloy layer 131 thereof alone or together at the same time.

Step S1-5) (optional) The lithium metal layer 112 comprises an active lithium (Active Li⁰/Li⁺ or lithium ion) 1121 or an inactive lithium 1122 (uncycleable SEI, lithium metal or dead lithium). When the inactive lithium formed, the polysulfide 111 can oxidize such inactive lithium 1122 to the active lithium 1121.

<Method for Forming the Lithiophilic Metal, the Metalloid, and/or the Alloy Layer Thereof at Negative Electrode>

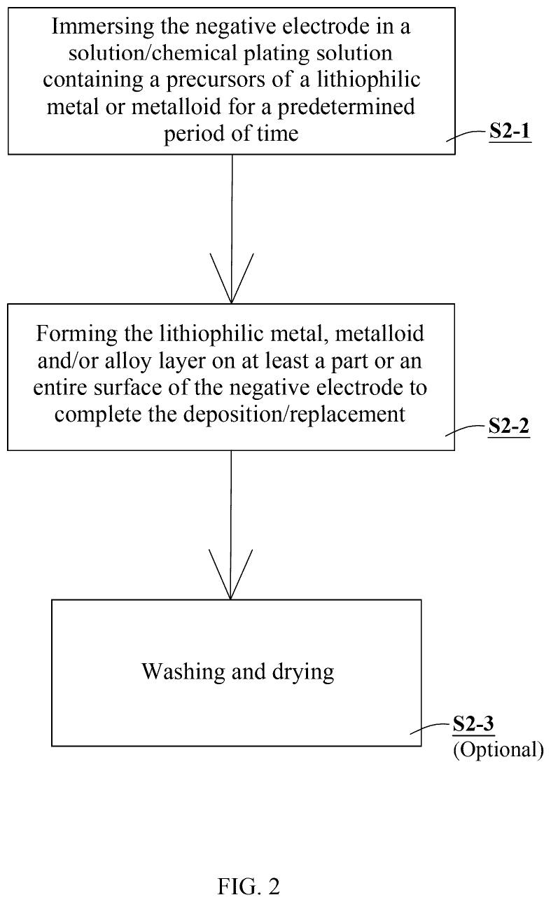

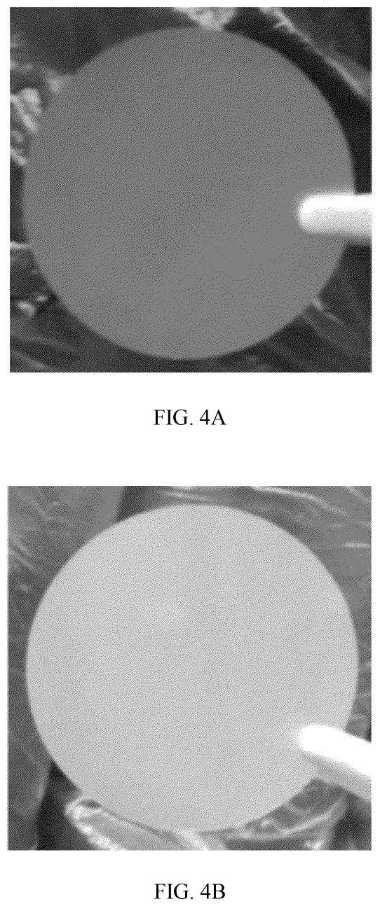

The method of the present invention for coating the surface of the negative electrode 13 with the lithiophilic metal, the metalloid, and/or the alloy layer 131 thereof is preferably a solution deposition or replacement method, such as a preferred embodiment of chemical plating. Referring to FIG. 2, FIG. 4A and FIG. 4B, the chemical plating steps of said preferred embodiment comprise:
Step S2-1) Immersing the negative electrode 13, in this case, a copper foil, in a solution/chemical plating solution containing a precursor of a lithiophilic metal or metalloid for a predetermined period of time;
Step S2-2) Forming the lithiophilic metal, metalloid and/or alloy layer 131 thereof on at least a part or an entire surface of the negative electrode 13 to complete the deposition/replacement;
Step S2-3) (optionally) washing and drying.

Wherein the solution/chemical plating solution containing the lithiophilic metal or metalloid described in the previous Step S2-1 comprises a solvent containing at least the lithiophilic metal or metalloid compound or the suitable solvent as shown in the formulation table in Table 1 below, this embodiment uses a thiourea-based solution containing tin. The predetermined time required for the deposition or replacement method provided herein may vary depending on the concentration of the solution/chemical plating solution containing the lithiophilic metal or metalloid, e.g., preferably less than 2 minutes, or better yet less than 1.5 minutes, which is sufficient to form a substantially effective thickness of the lithiophilic metal, the metalloid, and/or the alloy layer 131 thereof on the surface of the negative electrode 13. FIGS. 4A and 4B are the optical images of the copper foil of the negative electrode 13 before and after the chemical plating treatment of the preferred embodiment described above, and of FIG. 4B which shows the lithiophilic metal, the metalloid, and/or the alloy layer 131 thereof uniformly distributed on the surface of the negative electrode 13.

TABLE 1
Tin-containing solutions.

| | Range of | |
|---|---|---|
| Composition | Content | Embodiment |
| SnCl₂ | 0.1~5 g | 0.5 g |
| CTAB | 0.1~5 g | 0.5 g |
| Thiourea | 0.1~10 g | 4.5 g |
| H₂SO₄ | 0.1~10 ml | 1 ml |
| DI water | 0.1~1000 g | 100 g |

### <Continuous Process>

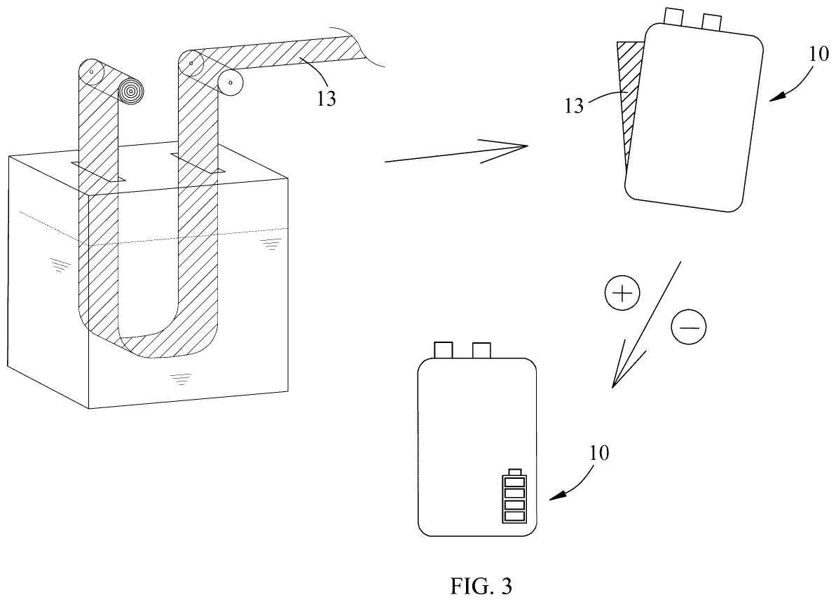

Referring to FIG. 3, the present invention is a method of a continuous process that combines the aforementioned deposition and replacement steps of forming the lithiophilic metal, the metalloid, and/or the alloy layer thereof on the negative electrode with the subsequent assembly onto the lithium-sulfur battery 10 for charging/discharging to increase the cycle life of the lithium-sulfur battery.

### <Lithium-Sulfur Battery>

As in FIG. 1, the present invention also provides a lithium-sulfur battery 10 produced by the aforementioned method in which the negative electrode 13 contains the lithiophilic metal, the metalloid, and/or the alloy layer 131 thereof, and the negative electrode 13 does not generate metal sulfide during charging, or better yet, a lithium metal layer 112 is formed underneath the lithiophilic metal, the metalloid, and/or the alloy layer 131 thereof.

### <Validation Test>

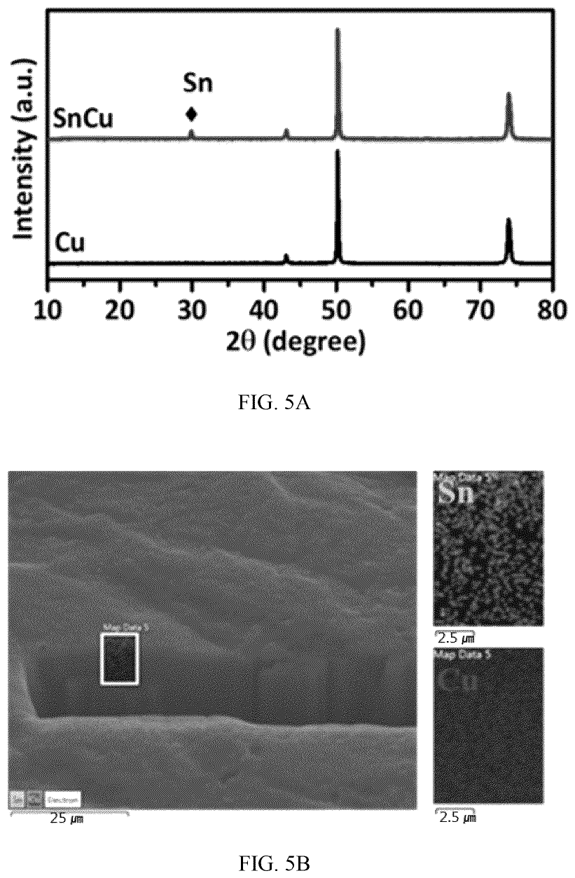

Referring to FIG. 5A, which is an X-ray diffraction (XRD) image of the negative electrode 13 before and after chemical plating corresponding to FIGS. 4A and 4B, it is shown from the XRD image that the tin or tin-copper alloy layer 131 is formed on the surface of the copper foil of the negative electrode 13, thus confirming that the lithiophilic metal, the metalloid, and/or the alloy layer 131 thereof can be distributed on the surface of the negative electrode 13 by chemical plating. For ease of understanding, the negative electrode 13 (bare copper foil) before chemical plating in this validation test corresponding to FIG. 3A may also be considered as a comparative example of the present invention.

Referring to FIGS. 5B and 5C, FIG. 5B is the elemental analysis results of focused ion beam (FIB) scanning electron microscopy (SEM) and focused ion beam (FIB) X-ray energy dispersion analysis (EDS) of the preferred embodiment of the negative electrode of the present invention, which shows that the lithiophilic metal, the metalloid, and/or the alloy layer 131 thereof is formed on the surface of the copper foil of the negative electrode 13 of the present invention. FIG. 5C shows the elemental analysis signal of the negative electrode 13 coated with the lithiophilic metal, the metalloid, and/or the alloy layer 131 thereof. Also, converted from FIG. 5C, the elemental state of tin and copper in the lithiophilic metal, the metalloid, and/or the alloy layer 131 thereof of this embodiment can be obtained as listed in Table 2 below.

TABLE 2

| | Percentage | Percentage |
|---|---|---|
| Element | of Weight | of Atoms |
| Copper | 97.4 | 98.6 |
| Tin | 2.6 | 1.4 |
| Total | 100 | 100 |

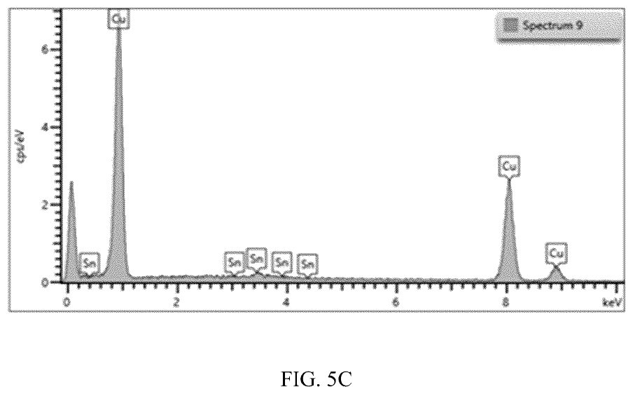

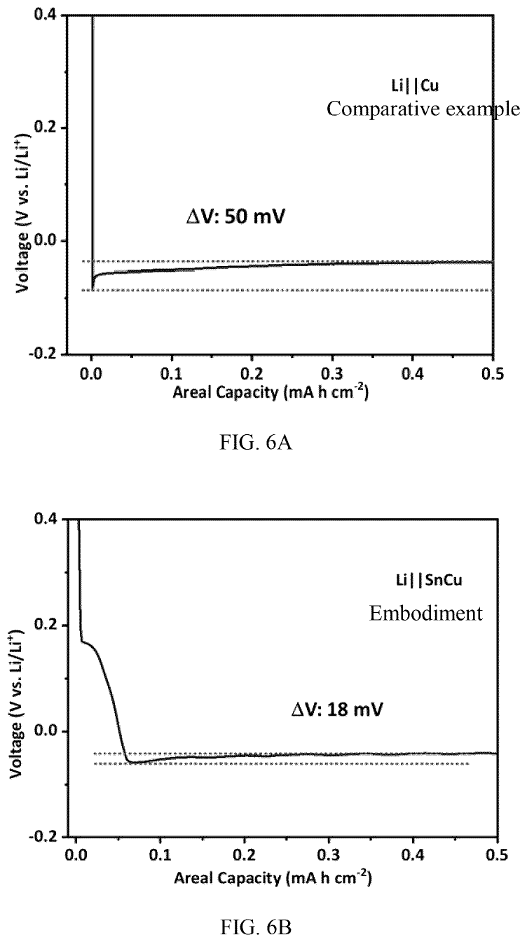

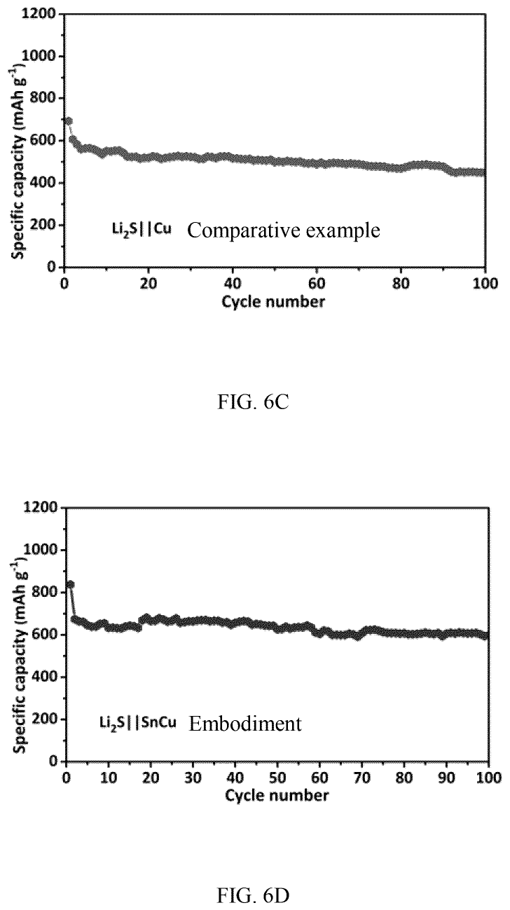

Referring to FIGS. 6A and 6B, which show the nucleation potential performance of the comparative example (bare copper foil) and the embodiment of the present invention, it can be seen from FIGS. 6A and 6B that the embodiment of the present invention has a lower nucleation potential, which confirms that the lithium affinity property of tin metal can reduce the nucleation potential of lithium on the surface of the negative electrode. Meanwhile, FIGS. 6C and 6D show the capacitance analysis of the comparative example (bare copper foil) and the embodiment of the present invention, and it can be seen that after 100 charging and discharging cycles, the embodiment of the present invention still maintains a capacity of at least 600 mAh g-1, which is superior to the comparative example.

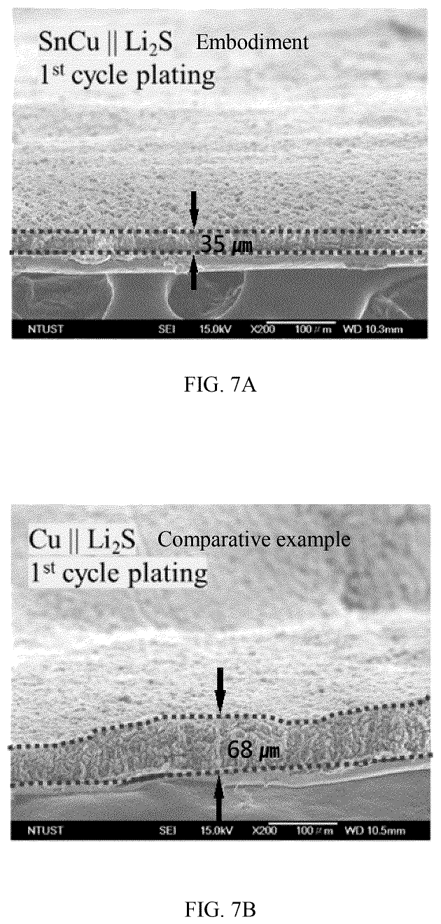

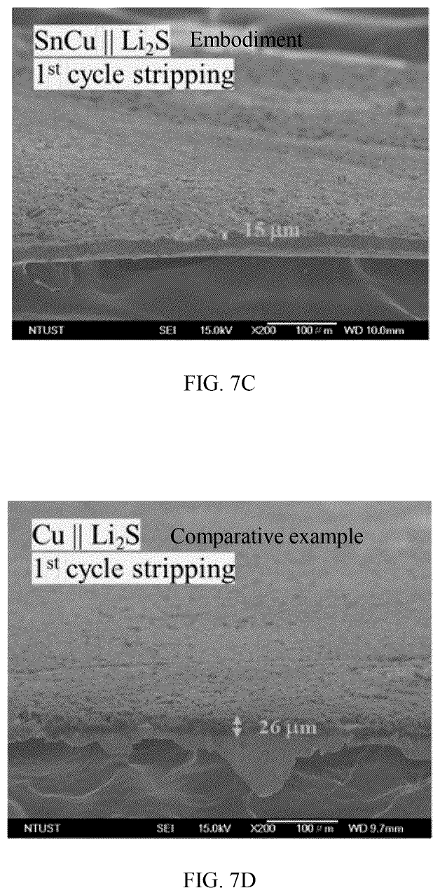

Referring to FIGS. 7A and 7B, the surface pattern observation (SEM image) of the negative electrode 13 after at least one charge of the lithium-sulfur battery 10 made by the embodiment of the present invention and the comparative example (bare copper foil), it can be clearly seen that the tin or tin-copper alloy layer 131 and the lithium metal layer 112 are formed on the surface of the copper foil of the negative electrode 13 of the embodiment of the present invention, and the thickness of the lithium metal layer 112 is thinner than that of the comparative example of FIG. 7B because the deposited lithium metal layer 112 is denser. Due to the lithium affinity properties of the lithiophilic metal, the metalloid, and/or the alloy layer 131 thereof, a thinner and denser lithium metal layer 112 is formed on the surface of the negative electrode 13, and less lithium dendrites and dead lithium are found.

Next, comparing FIG. 7C with FIG. 7D, which are the surface pattern observation (SEM image) of the bare copper foil of the negative electrode after at least one discharge of the lithium-sulfur battery also made by the embodiment of the present invention and the comparative example (bare copper foil), it can be clearly seen that the dense lithium metal layer 112 deposited by the present invention returns to the positive electrode 11 to a large extent after the discharge, leaving only very few (thin) lithium dendrites, dead lithium, or poor solid electrolyte interface (SEI). Compared with the thicker and looser lithium dendrites and dead lithium formed on the surface of the bare copper foil, it significantly affects the electrical performance of the lithium-sulfur battery.

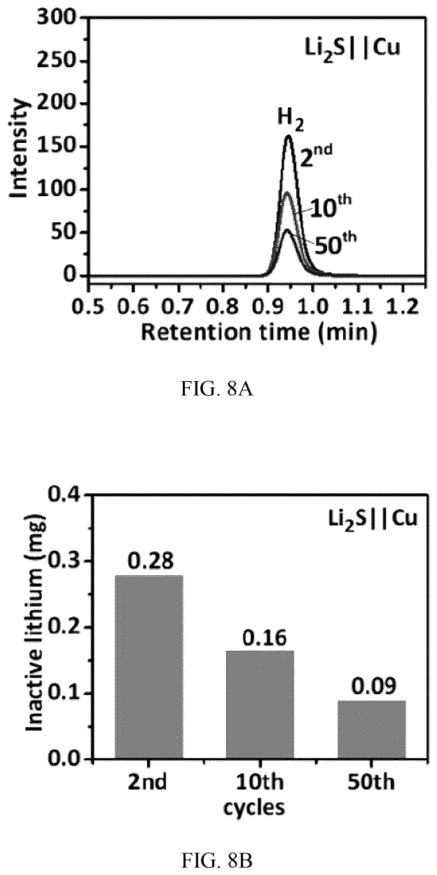

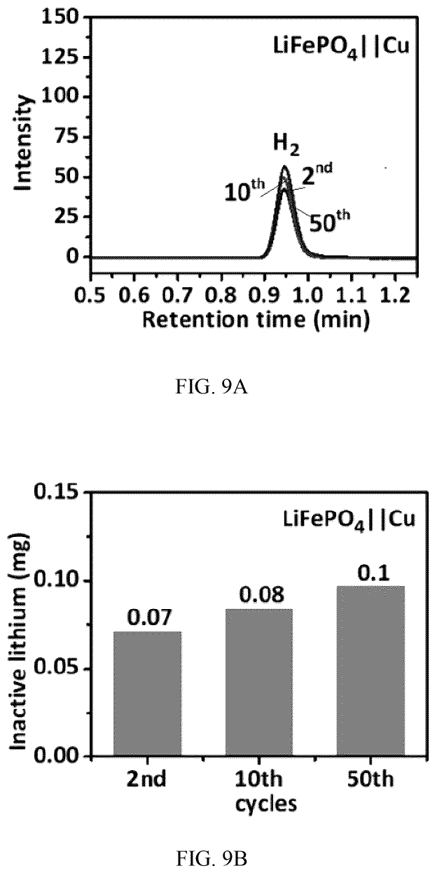

Please refer to FIG. 8A and FIG. 8B, GC chromatogram of H₂ gas after H₂O titration on inactive (dead) lithium from the negative electrode after the 2^{nd}, 10^{th} and 50^{th} cycles of the lithium-sulfur battery made by the embodiment of the present invention are presented. The measured H₂ gas signal intensities reduced in the present invention. FIG. 9A and FIG. 9B are GC chromatogram of H₂ gas after H₂O titration on inactive (dead) lithium from the negative electrode after the 2^{nd}, 10^{th} and 50^{th} cycles of the lithium-sulfur battery made by the comparative example (with bare copper foil). The measured H₂ gas signal intensities increased in the comparative example. The results indicate the polysulfide redox species in the battery involved in retrieving inactive (dead) lithium for compensating lithium loss during the electrochemical cycling of cells. It is worth to notice that the above mentioned lithium-sulfur battery is preferred to be anode-free lithium-sulfur battery.

The above specification, examples, and data provide a complete description of the present disclosure and use of exemplary embodiments. Although various embodiments of the present disclosure have been described above with a certain degree of particularity, or with reference to one or more individual embodiments, those with ordinary skill in the art could make numerous alterations or modifications to the disclosed embodiments without departing from the spirit or scope of this disclosure.

What is claimed is:

1. A method for increasing the cycle life of an electrochemical device, the steps of which comprise:
providing an electrochemical device consisting of at least a positive electrode, a negative electrode, and a separator;
charging the electrochemical device, the positive electrode generates a polysulfide and shuttles through the separator to the negative electrode;
multiple lithium ions from the positive electrode deposit a lithium metal layer at the negative electrode, the lithium metal layer comprises an active lithium or an inactive lithium; and
the polysulfide oxidizes the inactive lithium into the active lithium when the inactive lithium is formed; wherein the polysulfide is MₓS_{y} where M comprises Li, Al, Na, K, Mg, Ca or Zn; x=0˜2 and y=1˜8.

2. The method according to claim 1, wherein the electrochemical device comprises anode-free lithium-sulfur battery.

3. The method according to claim 1, wherein the polysulfide reduces or does not generate a metal sulfide with the negative electrode.

4. The method according to claim 1, wherein the negative electrode is at least partially or entirely coated with a lithiophilic metal, a metalloid, and/or an alloy layer thereof; and the multiple lithium ions from the positive electrode deposit the lithium metal layer between the negative electrode and the lithiophilic metal, a metalloid, and/or an alloy layer thereof.

5. The method according to claim 2, wherein the polysulfide reduces or does not generate a metal sulfide with the negative electrode.

6. The method according to claim 1, wherein the negative electrode is coated with the lithiophilic metal, the metalloid, and/or the alloy layer thereof using solution deposition or replacement.

7. The method according to claim 1, wherein the lithiophilic metal includes strontium, gallium, antimony, magnesium, calcium, barium, scandium, yttrium, aluminum, indium, thallium, germanium, tin, lead, antimony, bismuth, selenium, tellurium, rhodium, iridium, palladium, platinum, silver, gold, zinc, cadmium, titanium, molybdenum, mercury, or combinations thereof; and the lithiophilic metalloid includes carbon, silicon, arsenic, or combinations thereof.

8. The method according to claim 2, wherein the lithiophilic metal includes strontium, gallium, antimony, magnesium, calcium, barium, scandium, yttrium, aluminum, indium, thallium, germanium, tin, lead, antimony, bismuth, selenium, tellurium, rhodium, iridium, palladium, platinum, silver, gold, zinc, cadmium, titanium, molybdenum, mercury, or combinations thereof; and the lithiophilic metalloid includes carbon, silicon, arsenic, or combinations thereof.

9. The method according to claim 3, wherein the lithiophilic metal includes strontium, gallium, antimony, magnesium, calcium, barium, scandium, yttrium, aluminum, indium, thallium, germanium, tin, lead, antimony, bismuth, selenium, tellurium, rhodium, iridium, palladium, platinum, silver, gold, zinc, cadmium, titanium, molybdenum, mercury, or combinations thereof; and the lithiophilic metalloid includes carbon, silicon, arsenic, or combinations thereof.

10. The method according to claim 1, wherein
the positive electrode comprises a sulfur-containing positive electrode material;
the negative electrode is a current collector and comprises a metal foil; and
the separator is a porous film.

11. The method according to claim 2, wherein
the positive electrode comprises a sulfur-containing positive electrode material;
the negative electrode is a current collector and comprises a metal foil; and
the separator is a porous film.

12. The method according to claim 10, wherein
the sulfur-containing positive electrode material comprises lithium sulfide; and
the metal foil comprises a copper foil, an aluminum foil, a nickel foil, a stainless steel or indium foil.

13. The method according to claim 11, wherein
the sulfur-containing positive electrode material comprises lithium sulfide; and
the metal foil comprises a copper foil, an aluminum foil, a nickel foil, a stainless steel or indium foil.

14. The method according to claim 6, wherein the solution is deposited or replaced by immersing the negative electrode in a solution containing a precursors of a lithiophilic metal or metalloid such that the lithiophilic metal, the metalloid, and/or the alloy layer thereof is deposited or replaced on the surface of the negative electrode.

15. The method according to claim 14, wherein the precursors of the lithiophilic metal or metalloid comprises SnCl₂, CTBA, Thiourea, H₂SO₄, and DI water.

16. The method according to claim 6, wherein immersing the negative electrode in the solution containing the precursors of the lithiophilic metal or metalloid for less than 2 minutes.

17. The method according to claim 1, wherein the negative electrode is first coated with the lithiophilic metal, the metalloid and/or the alloy layer thereof on its surface by using solution for deposition and replacement, and then assembled with the electrochemical device for charging/discharging as a continuous process.

18. The method according to claim 2, wherein the negative electrode is first coated with the lithiophilic metal, the metalloid and/or the alloy layer thereof on its surface by using solution for deposition and replacement, and then assembled with the anode-free lithium-sulfur battery for charging/discharging as a continuous process.

19. An electrochemical device produced by the method as claimed in claim 1, comprising at least:
a positive electrode, a negative electrode, and a separator;
multiple lithium ions from the positive electrode deposit a lithium metal layer at the negative electrode; the lithium metal layer comprises an active lithium or an inactive lithium; and
the polysulfide oxidizes the inactive lithium into the active lithium when the dead lithium formed.
